(19) United States
(12) Patent Application Publication
(10) Pub. No.: US 2018/0129205 A1
(43) Pub. Date: May 10, 2018

(54) AUTOMATIC DRIVING SYSTEM AND METHOD USING DRIVING EXPERIENCE DATABASE

(71) Applicant: Electronics and Telecommunications Research Institute, Daejeon (KR)

(72) Inventors: Jeong Dan CHOI, Daejeon (KR); Joo Chan SOHN, Daejeon (KR); Kyoung Wook MIN, Sejong-si (KR); Seung Jun HAN, Daejeon (KR); Hyun Jeong YUN, Daejeon (KR)

(73) Assignee: Electronics and Telecommunications Research Institute, Daejeon (KR)

(21) Appl. No.: 15/794,952

(22) Filed: Oct. 26, 2017

(30) Foreign Application Priority Data
Nov. 10, 2016 (KR) 10-2016-0149517
Nov. 10, 2016 (KR) 10-2016-0149518

(51) Int. Cl. G05D 1/00; G06N 99/00

(52) U.S. Cl. CPC G05D 1/0088; G06N 99/005

(57) ABSTRACT

Provided are an automatic driving system and method using a driving experience database for safe driving by traffic situations. The automatic driving method includes receiving driving information about surrounding vehicles located near a first vehicle, receiving information about the event and driving information about the first vehicle when an event which is set for the first vehicle occurs, storing the driving information about the surrounding vehicles and the driving information about the first vehicle in association with the information about the event to build a database, and performing learning on a driving behavior of the first vehicle, based on the occurrence of the event.

### CROSS-REFERENCE TO RELATED APPLICATIONS

This application claims priority under 35 U.S.C. § 119 to Korean Patent Application No. 10-2016-0149517, filed on Nov. 10, 2016, and Korean Patent Application No. 10-2016-0149518, filed on Nov. 10, 2016, the disclosure of which is incorporated herein by reference in its entirety.

### TECHNICAL FIELD

The present invention relates to an automatic driving system and method using a driving experience database for safe driving by traffic situations.

### BACKGROUND

Recently, research on automatic driving is being actively done. It is required to determine driving conditions, such as a driving direction, a driving speed, etc., based on accurate recognition and recognized information of an external environment using sensors, for automatic driving.

Radars and the like are being used for recognition of an external environment, but vision sensors are being actively used for recognizing more information. The vision sensors are relatively inexpensive in comparison with other sensors, and thus, are attracting much attention. In this context, vehicle external environment recognition technology based on pattern recognition, image processing, machine learning, deep learning, and/or the like is being considerably developed and is expected to greatly help automatic driving.

In order to establish an intelligent traffic system, each country have much interest for a long time, relevant international standard is being prepared. For example, in association with messages for ‘Road Guidance Protocol (RGP)’ and ‘Unified Gateway Protocol (UGP)’, standard has been established in ISO/TC204, and standards of ‘Cooperative Awareness Messages (CAMs)’ and ‘Decentralized Environmental Notification Messages (DENMs)’ have been established in ETSI, CEN/TC278, and ISO/TC204, for ‘Local Dynamic Map (LDM)’.

Particularly, the LDM may be classified into four types including Type 1 to Type 4 in association with map information, based on a dynamic characteristic of information. Here, Type 1 information is map information about roads and buildings and is ‘static’ information, Type 2 information is ‘quasi-static’ information and corresponds to information such as landmarks and traffic signs, Type 3 information is ‘Dynamic’ information and corresponds to traffic jams, traffic lights information, traffic accident information, construction section information, and information about road surfaces, and Type 4 information is ‘Highly Dynamic’ information and corresponds to information about surrounding vehicles and pedestrians. If the Type 1 information is dynamic characteristic information which is changed for several months to several years, the Type 4 information may be very dynamic information which is changed for several seconds.

The LDM is very important for the intelligent traffic system, but should process more precise information in order to be used for automatic driving. For example, the Type 1 information needs a level of three-dimensional (3D) map data instead of a level of conventional two-dimensional (2D) map data. That is, a high-precision 3D map is needed for automatic driving, and Google, Uber, Here, etc. are investing large capital for developing the map. The high-precision 3D data is expected to be commercially used soon.

As the high-precision 3D map has been developed and a precision of surrounding situation recognition by sensors becomes higher, automatic driving technology is also expected to greatly advance, but discussion about determination of safe driving from recognized surrounding situations is insufficient yet. In automatic driving vehicles, if a 3D map and sensors correspond to eyes, it is yet required to further discuss brain for determination of automatic driving. That is, it is required to develop a driving program for automatic driving based on digital map information and sensor information.

Even though the driving program has been developed, if the driving program is a simple program which uses only road situation information provided from an intelligent traffic system (ITS) and is being discussed at present, it is insufficient to fulfill automatic driving.

In addition to such information, real-time driving information about surrounding vehicles, weather information, information about states of road surfaces of roads, and traffic situation information about a driving road section and a surrounding section thereof should be overall considered, and moreover, driving experience information about actual driving experiences of drivers should be used.

Particularly, since driving experiences of persons are experiences of safe driving in overall consideration of external environment situations such as weather and road surface states and driving situations of surrounding vehicles, experience data can be very useful if the experience data can be used for an automatic driving program.

If driving experience data is combined with artificial intelligence (AI) which is being actively researched recently, a very useful automatic driving program can be implemented.

### SUMMARY

Accordingly, the present invention provides an automatic driving system and method using a driving experience database, which build a database including driving experience data of drivers, cause learning of the driving experience data of the automatic driving system to finish an automatic driving algorithm, and perform automatic driving by using the automatic driving algorithm, in order to complement deficiency in automatic driving.

In one general aspect, an automatic driving method using a driving experience database includes: receiving driving information about surrounding vehicles located near a first vehicle; when an event which is set for the first vehicle occurs, receiving information about the event and driving information about the first vehicle; storing the driving information about the surrounding vehicles and the driving information about the first vehicle in association with the information about the event to build a database; and performing learning on a driving behavior of the first vehicle, based on the occurrence of the event.

Other features and aspects will be apparent from the following detailed description, the drawings, and the claims.

### BRIEF DESCRIPTION OF THE DRAWINGS

FIG. 1 is a diagram schematically illustrating an automatic driving system using a driving experience database according to an embodiment of the present invention.

FIG. 2 is a diagram illustrating a surrounding vehicle setting method according to an embodiment of the present invention.

FIG. 3 is a diagram illustrating a surrounding vehicle information collecting method according to an embodiment of the present invention.

FIG. 4 is a flowchart for describing a process of securing driving experience data according to an embodiment of the present invention.

FIG. 5 is a diagram illustrating a process of learning an automatic driving algorithm by using driving experience data, according to an embodiment of the present invention.

FIG. 6 is a diagram illustrating a method of using an automatic driving system according to an embodiment of the present invention.

FIG. 7 is a view illustrating an example of a computer system in which a method according to an embodiment of the present invention is performed.

### DETAILED DESCRIPTION OF EMBODIMENTS

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

In describing elements of the present invention, the terms “first”, “second”, “A”, “B”, “(a)”, and “(b)” may be used. The terms are merely for differentiating one element from another element, and the essence, sequence, or order of a corresponding element should not be limited by the terms. In this disclosure below, when it is described that one comprises (or includes or has) some elements, it should be understood that it may comprise (or include or has) only those elements, or it may comprise (or include or have) other elements as well as those elements if there is no specific limitation. Moreover, each of terms such as “ . . . unit”, “ . . . apparatus” and “module” described in specification denotes an element for performing at least one function or operation, and may be implemented in hardware, software or the combination of hardware and software.

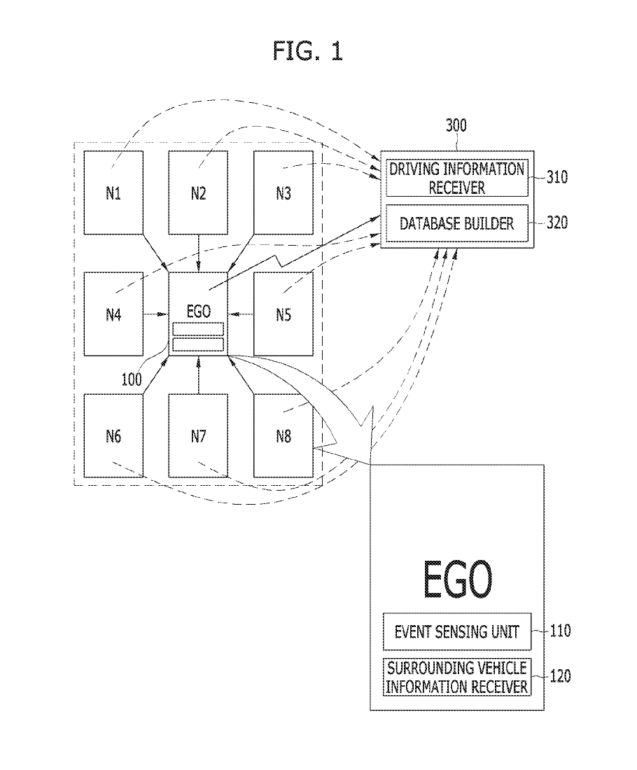

FIG. 1 is a diagram schematically illustrating an automatic driving system using a driving experience database according to an embodiment of the present invention.

A first vehicle 100 may include an event sensing unit 110 and a surrounding vehicle information receiver 120.

The event sensing unit 110 may be included in the first vehicle 100 and may sense whether an event which is set for the first vehicle 100 occurs.

Here, the event may be one of quick braking, abrupt acceleration, sudden deceleration, sudden acceleration, a sudden lane change, a sudden steering angle change, airbag deployment, a clash or collision accident, and an incident situation (for example, appearance of an animal, a falling rock, appearance of an obstacle, and the quick braking or traffic accident of a surrounding road user, etc.).

Moreover, the event may be a situation where a specific condition which is systemically set is satisfied. For example, when the event is more than or less than a predetermined driving speed or acceleration, a lane change and/or acceleration or deceleration which is performed a predetermined plurality of times or more for a predetermined time may be set as the event. In this case, the event may be differently determined based on content of driving experience data which is to be obtained.

The surrounding vehicle information receiver 120 may receive driving information from surrounding vehicles N1 to N8 near the first vehicle 100.

In this case, the driving information may include at least one of a model, a driving direction, a driving speed, a driving lane, global positioning system (GPS) information, braking information, and steering angle information of a corresponding vehicle.

Here, the surrounding vehicles may include at least one of vehicles which are located within a predetermined range with respect to the first vehicle 100 and are located in left front of, in front of, in right front of, to the left of, to the right of, left behind, behind, and right behind the first vehicle 100.

Each of the surrounding vehicles may be a four-wheel vehicle, a three-wheel vehicle, or a two-wheel vehicle.

A server 300 may include a driving information receiver 310 and a database builder 320.

The driving information receiver 310 may be included in the server 300 may receive driving information about surrounding vehicles from the surrounding vehicle information receiver 120.

In another embodiment, as illustrated in FIG. 1, the driving information receiver 310 may receive driving information from each of a plurality of surrounding vehicles.

The driving information receiver 310 may receive event information and driving information about the first vehicle 100 from the surrounding vehicle information receiver 120.

Here, the driving information about the first vehicle 100 may include at least one of a model, a driving direction, a driving speed, a driving lane, GPS information, braking information, and steering angle information of a corresponding vehicle.

The driving information about the surrounding vehicles or the driving information about the first vehicle 100 may include at least one of driving information previous to a time when the event occurs, driving information at the time when the event occurs, and driving information after the time when the event occurs.

Moreover, the driving information receiver 310 may receive at least one of weather information, information about a state of a road surface of a road, traffic congestion information, construction section information, and information about obstacles on the road in a district where the first vehicle 100 is driving.

Data may be provided from an institution managing the data or a roadside base station.

The database builder 320 may store the received surrounding vehicle driving information and driving information about the first vehicle 100 in association with the information about the event to build a database.

A network (not shown) may denote a communication network which transmits or receives data according to a communication protocol by using wired/wireless communication technology and may transmit or receive data of the event sensing unit 110, the surrounding vehicle information receiver 120, and the server 300.

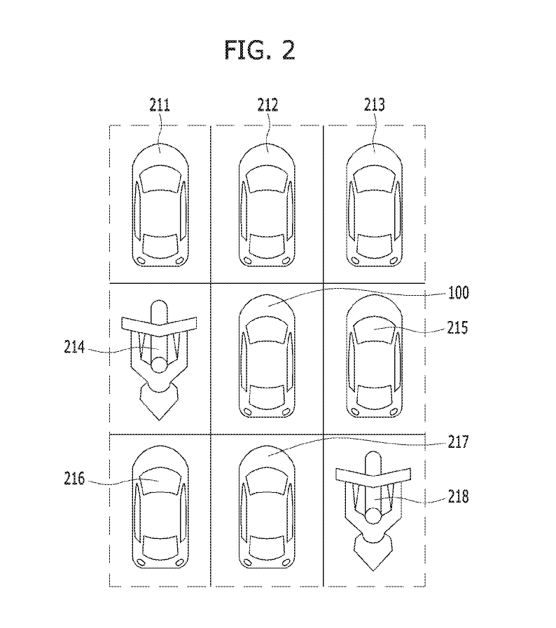

FIG. 2 is a diagram illustrating a surrounding vehicle setting method according to an embodiment of the present invention.

The first vehicle 100 may check surrounding vehicles which are located within a predetermined range with respect to the first vehicle 100. Here, as illustrated in FIG. 2, the predetermined range may be limited to a tetragonal range, but is not limited thereto. In other embodiments, the predetermined range may be limited to a circular range, a triangular range, etc.

According to an embodiment of the present invention, the first vehicle 100 may check a first surrounding vehicle 211 which is located within a left front range with respect to the first vehicle 100 within the predetermined range, a second surrounding vehicle 212 which is located within a front range, a third surrounding vehicle 213 which is located within a right front range, a fourth surrounding vehicle 214 which is located within a left range, a fifth surrounding vehicle 215 which is located within a right range, a sixth surrounding vehicle 216 which is located within a left rear range, a seventh surrounding vehicle 217 which is located within a rear range, and an eighth surrounding vehicle 218 which is located within a right rear range.

Here, the first to third surrounding vehicles 211 to 213 and the fifth to seventh surrounding vehicles 215 to 217 may be four-wheel vehicles, and the fourth surrounding vehicle 214 and the eighth surrounding vehicle 218 may be two-wheel vehicles.

In FIG. 2, the surrounding vehicles are illustrated as being located in left front of, in front of, in right front of, to the left of, to the right of, left behind, behind, and right behind the first vehicle 100, but are not limited thereto. In other embodiments, the surrounding vehicles may be located in one or more of areas in left front of, in front of, in right front of, to the left of, to the right of, left behind, behind, and right behind the first vehicle 100.

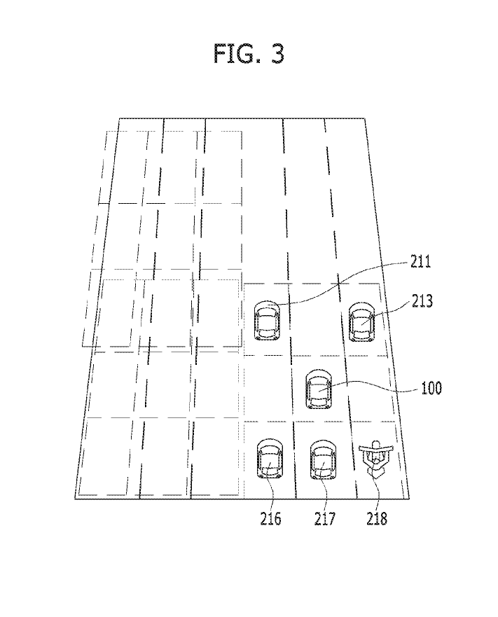

FIG. 3 is a diagram illustrating a surrounding vehicle information collecting method according to an embodiment of the present invention.

Referring to FIG. 3, the first surrounding vehicle 211 located within the predetermined range may be located in left front of the first vehicle 100, the third surrounding vehicle 213 may be located in right front of the first vehicle 100, the sixth surrounding vehicle 216 may be located left behind the first vehicle 100, the seventh surrounding vehicle 217 may be located behind the first vehicle 100, and the eighth surrounding vehicle 218 may be located in right front of the first vehicle 100.

Here, the first, third, sixth, and seventh surrounding vehicles 211, 213, 216, and 217 may be four-wheel vehicles, and the eighth surrounding vehicle 218 may be a two-wheel vehicle.

The event sensing unit 110 included in the first vehicle 100 may sense whether the event which is set for the first vehicle 100 occurs.

For example, when the first vehicle 110 suddenly changes a lane, the event sensing unit 110 may sense occurrence of the event.

When the event occurs, the driving information receiver 310 illustrated in FIG. 1 may receive at least one of weather information, information about a state of a road surface of a road, traffic congestion information, construction section information, and information about obstacles on the road in a district, where the first vehicle 100 is driving, from the first vehicle 100.

The driving information receiver 310 may receive sudden lane change information and driving information about the first vehicle 100, which are event information, from the surrounding vehicle information receiver 120.

The surrounding vehicle information receiver 120 illustrated in FIG. 1 may be included in the first vehicle 100 and may receive driving information about surrounding vehicles near the first vehicle 100.

Here, the surrounding vehicle information receiver 120 may receive driving information about each of the surrounding vehicles 211, 213, 216, 217, and 218.

The driving information receiver 310 may be included in the sever 300. The driving information receiver 310 may receive the driving information about the surrounding vehicles 211, 213, 216, 217, and 218 from the surrounding vehicle information receiver 120, or may receive the driving information from each of the surrounding vehicles 211, 213, 216, 217, and 218.

The database builder 320 of the sever 300 may store the driving information about each of the surrounding vehicles 211, 213, 216, 217, and 218 and the driving information about the first vehicle 100 in association with the event of the first vehicle 100 to build a database.

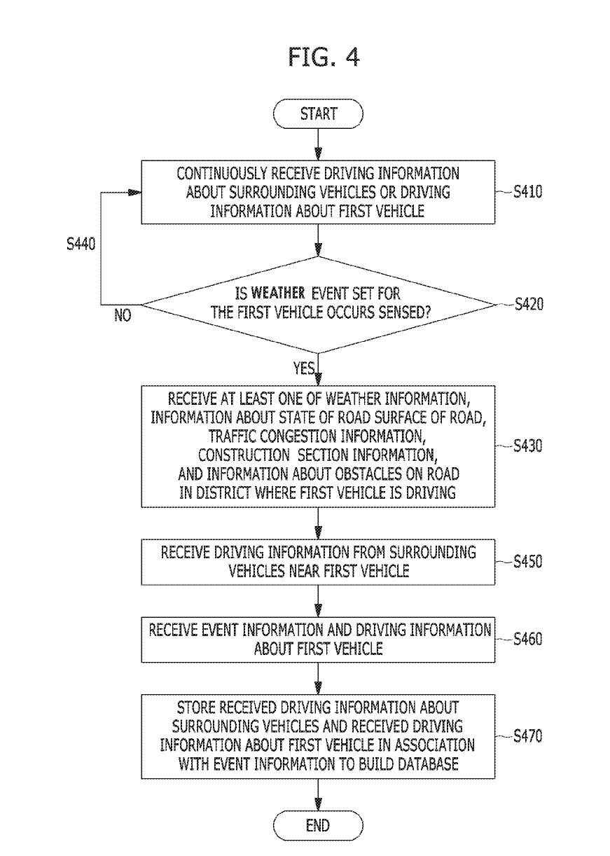

FIG. 4 is a flowchart for describing a process of securing driving experience data according to an embodiment of the present invention.

First, in step S410, driving information about surrounding vehicles or driving information about the first vehicle 100 may be received.

When the received driving information is the driving information about the surrounding vehicles, the driving information may be transmitted from the first vehicle 100 to the server 300, or may be directly transmitted from the surrounding vehicles to the server 300.

Here, whether the event which is set for the first vehicle 100 occurs may be sensed in step S420.

For example, when the first vehicle 100 is quickly braked or suddenly change a lane, occurrence of the event may be sensed.

Sensing of occurrence of the event may be performed by a system in the first vehicle 100, but is not limited thereto.

When the event which is set for the first vehicle 100 occurs, at least one of weather information, information about a state of a road surface of a road, traffic congestion information, construction section information, and information about obstacles on the road in a district where the first vehicle 100 is driving may be received in step S430.

In step S440, when the event which is set for the first vehicle 100 occurs, the process may return to step S410 where the driving information about the surrounding vehicles or the driving information about the first vehicle 100 is continuously received until the event occurs. For example, the first vehicle 100 may continuously receive the driving information from the surrounding vehicles (211, 213, 216, 217, and 218 in FIG. 3) to check whether the event occurs.

When the event occurs, the server 300 may receive the driving information from the surrounding vehicles in step S450.

The driving information about the surrounding vehicles may be transmitted from the first vehicle 100 to the server 300, or may be directly transmitted from the surrounding vehicles to the server 300.

When the driving information about the surrounding vehicles is directly transmitted from the surrounding vehicles to the server 300, for example, the server 300 may receive a signal indicating occurrence of the event from the first vehicle 100 in the middle of continuously receiving the driving information about the first vehicle 100 and/or the surrounding vehicles, thereby securing data by storing the driving information about the surrounding vehicles obtained before and after a corresponding time.

In step S460, the server 300 may receive event information and the driving information about the first vehicle 100.

Subsequently, in step S470, a database may be built by storing the received driving information about the surrounding vehicles and the received driving information about the first vehicle 100 in association with the event information.

In FIG. 4, steps S410 to S470 are described as being sequentially performed, but the description is merely the exemplary description of the technical spirit of the present embodiment. Those skilled in the art may make various corrections and modifications by changing the order described in FIG. 4 to perform the operations or performing one or more of steps S410 to S470 in parallel without departing from the essential characteristic of the present embodiment, and thus, FIG. 4 is not limited to the time-series order.

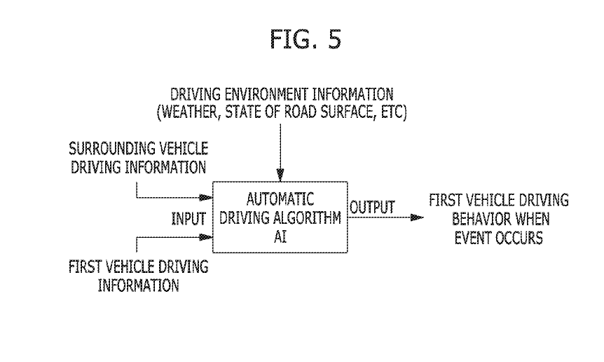

Driving experience data obtained by the above-described method, as illustrated in FIG. 5, may be used to cause learning of an automatic driving program or a system.

That is, an automatic driving algorithm may be learned and finished through an AI algorithm by using various surrounding vehicle driving information and first vehicle driving information, occurring in various situations, as learning materials.

In this case, input data may be the driving information about the first vehicle 100 and driving information about the surrounding vehicle 220 before the event occurs.

The automatic driving algorithm may be learned through deep learning by using, as output data, at least one of steering angle information, braking information, acceleration information, deceleration information, transmission information, and engine fuel supply information in a driving behavior of the first vehicle 100 at a time when the event occurs.

In this case, at least one of weather information, information about a state of a road surface of a road, traffic congestion information, construction section information, and information about obstacles on the road in a district where the first vehicle 100 is driving when the event occurs may be used as materials for learning the automatic driving algorithm.

Such driving environment information such as the weather information may be obtained from an institution managing the data or a roadside base station.

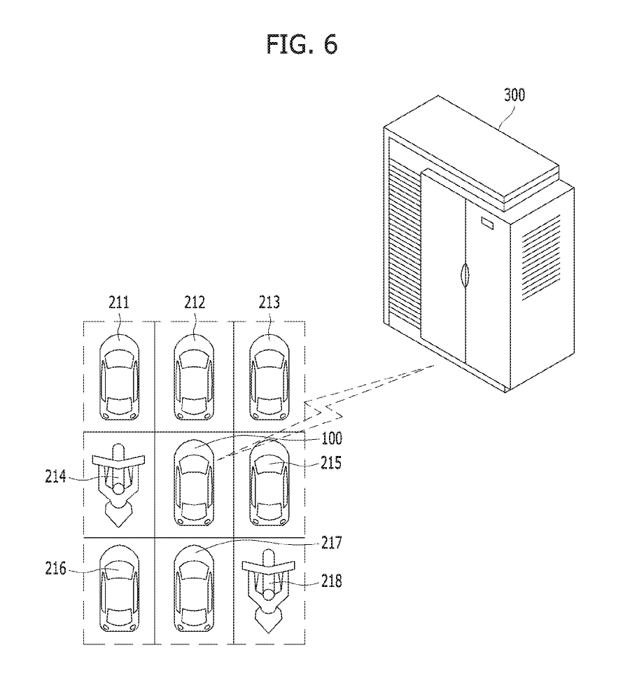

Hereinafter, a process where automatic driving is performed by the automatic driving system according to an embodiment of the present invention will be described with reference to FIG. 6.

First, the automatic driving system may be installed in the first vehicle 100.

Surrounding vehicles are driving near the first vehicle 100 together. For example, three four-wheel vehicles 211 to 213 may be driving in front of the first vehicle 100, a two-wheel vehicle 214 may be driving to the left of the first vehicle 100, a four-wheel vehicle 215 may be driving to the right of the first vehicle 100, and two four-wheel vehicles 216 and 217 and a two-wheel vehicle 218 may be driving behind the first vehicle 100.

The first vehicle 100 may be in the middle of performing V2V communication with the surrounding vehicles 211 to 218 and may receive driving information about the surrounding vehicles 211 to 218 through the communication.

Moreover, some or all of the driving information about the surrounding vehicles 211 to 218 may be obtained through sensors equipped in the first vehicle 100, in addition to the communication.

The first vehicle 100 may be in the middle of performing communication with the server 300 and may receive at least one of weather information, information about a state of a road surface of a road, traffic congestion information, construction section information, and information about obstacles on the road in a district, where the first vehicle 100 is driving, as driving environment information from the server 300.

In this case, as illustrated in FIG. 1, the server 300 may be a server which includes the driving information receiver 310 and the database builder 320, or may be a separate environment information server.

Front traffic congestion information, traffic accident information, construction section information, and information about obstacles on a road may be received through the V2V communication from other vehicles which are driving in front of the first vehicle 100, in addition to the server 300. Limitations of sensors are overcome by exchanging information with another vehicle through the V2V communication, and moreover, information may be obtained in real time in comparison with the server 300.

The automatic driving system equipped in the first vehicle 100 may output data for controlling driving of the first vehicle 100 by using, as input data, driving information and/or driving environment information about the surrounding vehicles 211 to 218.

For example, at least one of steering angle data, braking data, acceleration data, deceleration data, transmission data, and engine fuel supply data may be output as driving behavior control data.

Furthermore, the output data may be used as control data of a corresponding system or component, and thus, driving of the first vehicle 100 may be controlled. For example, the steering angle data output as the driving behavior control data may be used to control steering of the first vehicle 100, and the braking data may be used to control a brake of the first vehicle 100.

By repeating such a process, the automatic driving system may perform automatic driving on the first vehicle 100.

The automatic driving system may include an algorithm generated through deep learning from driving experience data of a person which achieves safe driving, based on driving environment information and driving information about surrounding vehicles. Accordingly, an appropriate action may be performed in various situations which occur in automatic driving, and moreover, a driving behavior similar to a driving habit of the person may be achieved, thereby fulfilling automatic driving without a sense of incompatibility.

In the above-described embodiments, the present invention is applied to an example where a road user is a vehicle, but the present invention is not limited thereto.

According to the embodiments of the present invention, experience data of safe driving may be secured, and an experience data database may be built by using the secured experience data and may be very usefully used for development of an automatic driving program.

By learning driving experience data of road users through an AI algorithm, an automatic driving program which enables safe driving in various situations may be developed, and the driving experience data may be used as big data for establishing a traffic system.

The automatic driving system, which copes with driving states of surrounding vehicles in real time and achieves safe driving, may be realized.

Moreover, since driving experiences of road users are used, an automatic driving system which is very similar to a driving habit of a person may be realized, thereby providing an automatic driving system which enables familiar driving without a sense of incompatibility.

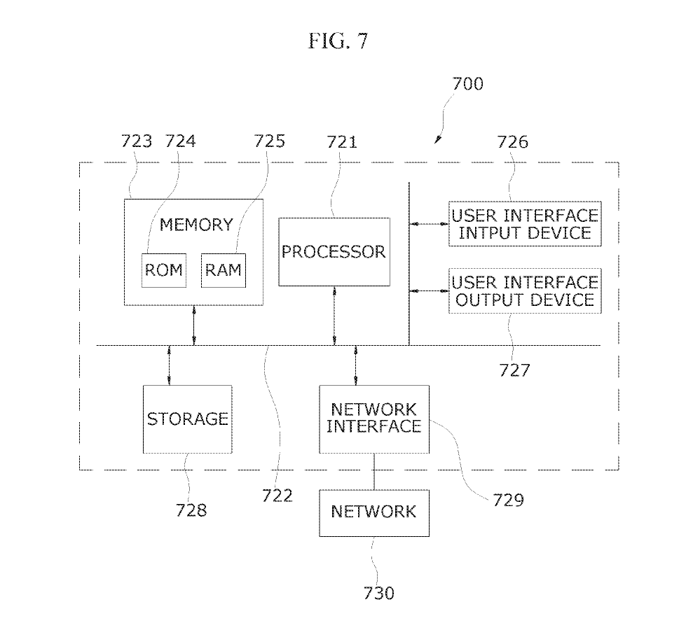

The method according to an embodiment of the present invention may be implemented in a computer system or may be recorded in a recording medium. FIG. 7 illustrates a simple embodiment of a computer system. As illustrated, the computer system may include one or more processors 11, a memory 13, a user input device 16, a data communication bus 12, a user output device 17, a storage 18, and the like. These components perform data communication through the data communication bus 12.

Also, the computer system may further include a network interface 19 coupled to a network. The processor 11 may be a central processing unit (CPU) or a semiconductor device that processes a command stored in the memory 13 and/or the storage 18.

The memory 13 and the storage 18 may include various types of volatile or non-volatile storage mediums. For example, the memory 13 may include a ROM 14 and a RAM 15.

Thus, the method according to an embodiment of the present invention may be implemented as a method that can be executable in the computer system. When the method according to an embodiment of the present invention is performed in the computer system, computer-readable commands may perform the producing method according to the present invention.

The method according to the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An automatic driving method using a driving experience database, the automatic driving method comprising:
receiving driving information about surrounding vehicles located near a first vehicle;
when an event which is set for the first vehicle occurs, receiving information about the event and driving information about the first vehicle;
storing the driving information about the surrounding vehicles and the driving information about the first vehicle in association with the information about the event to build a database; and
performing learning on a driving behavior of the first vehicle, based on the occurrence of the event.

2. The automatic driving method of claim 1, wherein the surrounding vehicles are located within a predetermined range with respect to the first vehicle.

3. The automatic driving method of claim 1, wherein the surrounding vehicles are located in at least one of areas in left front of, in front of, in right front of, to the left of, to the right of, left behind, behind, and right behind the first vehicle.

4. The automatic driving method of claim 1, wherein the driving information about the first vehicle and the driving information about the surrounding vehicles each comprise at least one of a model, a driving direction, a driving speed, a driving lane, global positioning system (GPS) information, braking information, and steering angle information of a corresponding vehicle.

5. The automatic driving method of claim 1, wherein the receiving of the driving information comprises:
receiving, by the first vehicle, the driving information from the surrounding vehicles or obtaining the driving information about the surrounding vehicles through sensors; and
receiving the driving information about the surrounding vehicles from the first vehicle.

6. The automatic driving method of claim 1, further comprising: receiving at least one of weather information, information about a state of a road surface of a road, traffic congestion information, construction section information, and information about obstacles on the road in a district where the first vehicle is driving.

7. The automatic driving method of claim 1, wherein the event may be one of quick braking, abrupt acceleration, sudden deceleration, sudden acceleration, a sudden lane change, a sudden steering angle change, airbag deployment, a clash or collision accident, and an incident situation.

8. The automatic driving method of claim 1, wherein the building of the database comprises building the database by using information, corresponding to a predetermined time range with respect to a time when the event occurs, of the driving information about the surrounding vehicles.

9. The automatic driving method of claim 1, wherein the performing of the learning comprises causing learning of an artificial intelligence algorithm by using, as input data, the driving information about the first vehicle and the driving information about the surrounding vehicles before the event occurs and by using, as output data, at least one of steering angle information, braking information, acceleration information, deceleration information, transmission information, and engine fuel supply information about the first vehicle at a time when the event occurs.

10. An automatic driving system using a driving experience database, the automatic driving system comprising:
a driving information receiver receiving driving information about a first vehicle and driving information about surrounding vehicles, and when an event which is set for the first vehicle occurs, receiving event information; and
a database builder storing the driving information about the surrounding vehicles and the driving information about the first vehicle in association with the event information and performing learning on a driving behavior of the first vehicle, based on the occurrence of the event.

11. The automatic driving system of claim 10, wherein the driving information receiver receives at least one of weather information, information about a state of a road surface of a road, traffic congestion information, construction section information, and information about obstacles on the road at a time when the event occurs.

12. The automatic driving system of claim 10, wherein the event comprises one of quick braking, abrupt acceleration, sudden deceleration, sudden acceleration, a sudden lane change, a sudden steering angle change, airbag deployment, a clash or collision accident, and an incident situation.

13. The automatic driving system of claim 10, wherein the database builder stores driving information, corresponding to a predetermined time range with respect to a time when the event occurs, of the driving information about the surrounding vehicles.

14. The automatic driving system of claim 10, wherein the database builder causes learning of an artificial intelligence algorithm by using, as input data, the driving information about the first vehicle and the driving information about the surrounding vehicles before the event occurs and by using, as output data, at least one of steering angle information, braking information, acceleration information, deceleration information, transmission information, and engine fuel supply information about the first vehicle at a time when the event occurs.
